(19) United States
(12) Patent Application Publication
(10) Pub. No.: US 2013/0278856 A1
(43) Pub. Date: Oct. 24, 2013

(54) Display Panel and Method for Reparing Signal Line of Display Panel

(71) Applicant: Cheng-hung Chen, Shenzhen (CN)

(72) Inventor: Cheng-hung Chen, Shenzhen (CN)

(73) Assignee: SHENZHEN CHINA STAR OPTOELECTRONICS TECHNOLOGY CO LTD., Shenzhen (CN)

(21) Appl. No.: 13/518,855

(22) PCT Filed: Apr. 25, 2012
(86) PCT No.: PCT/CN12/74643

§ 371 Date: Jun. 22, 2012

(30) Foreign Application Priority Data
Apr. 19, 2012 (CN) 201210117402.0

(51) Int. Cl. G02F 1/1333; H05B 6/00

(52) U.S. Cl. 349/54; 264/446

(57) ABSTRACT

The present invention provides a method of repairing a display panel and signal lines of the display panel. The method comprises: arranging a repairing line in a different layer with the signal line; arranging a transparent conductive layer above an intersectionally-overlapped area of the repairing line and the signal line, a melting point of the transparent conductive layer is lower than that of the signal line and the repairing line, and using laser beams to melt the transparent conductive layer to connect the signal line and the repairing line when repairing the broken signal line. The present invention arranges an additional transparent conductive layer with a lower melting point on an overlapped area of a repairing line and a signal line and uses the laser beams to melt the transparent conductive layer to connect the repairing line and the signal line, thereby increasing repairing possibility as repairing the signal line.

### BACKGROUND OF THE INVENTION

1. Field of the Invention

The present invention relates to a display technique, and more particularly, to a display panel and a method for repairing signal lines of the display panel.

2. Description of the Prior Art

A liquid crystal device comprises an array substrate, a color filter substrate and a liquid crystal layer filled between the two substrates. A large number of signal lines (such as scan line and data line) are set up in the array substrate. A number of signal lines, however, might be cracked in the process of manufacture on account of some manufacturing defects. Therefore, pixel electrodes in the cracked lines are unable to receive normal data signals, and it leads to display detects of a liquid crystal panel. Hence manufactures will take the defects into consideration to repair to decrease manufacturing cost before selling to markets.

The repairing lines and normal signal lines in the prior art are usually set up not only in different layers but also intersectionally overlapped. The laser beams concentrating to the intersectionally-overlapped area of the repairing lines and the signal lines are usually used to generate high heat energy at some partial area while the broken signal lines are being repaired. Such energy is capable of connecting the signal lines and the repairing lines by melting, so that data signals are able to be transmitted via the repairing lines. The energy of laser beams, however, gradually lessen as time elapses. It occurs easily that the signal lines and the repairing lines are melted ineffectively to attribute to a repairing failure or a problem of interface resistance in the intersectionally-overlapped area when the energy lessens to a certain degree.

Accordingly, it is necessary to propose a display panel and a method for repairing signal lines of the display panel.

### SUMMARY OF THE INVENTION

Therefore, an object of the present invention is to provide a method of repairing a display panel and signal lines of the display panel to increase a possibility of repairing signal lines.

According to the present invention, a method of repairing a signal line in a display panel, comprises the following steps: arranging a repairing line in a different layer with the signal line, the repairing line being set up above the signal line, the signal line being data line, scan line or common line; arranging a transparent conductive layer above an intersectionally-overlapped area of the repairing line and the signal line, a melting point of the transparent conductive layer is lower than that of the signal line and the repairing line; using laser beam to melt the transparent conductive layer to connect the signal line and the repairing line when repairing the broken signal line.

In one aspect of the present invention, the signal line is made of Aluminum or Copper. and the transparent conductive layer is made of Indium Tin Oxides (ITO) layer or Indium Zinc Oxides (IZO) layer.

According to the present invention, a method of repairing a signal line in a display panel, comprises the following steps: arranging a repairing line in a different layer with the signal line, arranging a transparent conductive layer above an intersectionally-overlapped area of the repairing line and the signal line, a melting point of the transparent conductive layer is lower than that of the signal line and the repairing line; using laser beam to melt the transparent conductive layer to connect the signal line and the repairing line when repairing the broken signal line.

In one aspect of the present invention, the repairing line is a data line, a scan line or a common line.

In another aspect of the present invention, the signal line is made of Aluminum or Copper, and the transparent conductive layer is made of Indium Tin Oxides(ITO) layer or Indium Zinc Oxides (IZO) layer.

In still another aspect of the present invention, the repairing line is set up above the signal line, the transparent layer is set up above the repairing line.

In yet another aspect of the present invention, the signal line is set up above the repairing line, the transparent layer is set up above the repairing line.

According to the present, a display panel comprises: a relatively-arranged array substrate, a color filter substrate and a liquid crystal layer clamped between the array substrate and the color filter substrate, a plurality of signal lines and repairing lines being set up in the array substrate and the repairing lines and the signal lines being set up intersectionally and respectively in different layers, wherein a transparent conductive layer is arranged above an intersectionally-overlapped area of the repairing lines and the signal lines, and a melting point of the transparent conductive layer is lower than that of the signal line and the repairing line.

In one aspect of the present invention, the signal line is data line, scan line or common line.

In another aspect of the present invention, the signal line is made of Aluminum or Copper, and the transparent conductive layer is made of ITO layer or IZO layer.

In still another aspect of the present invention, the repairing line is arranged above the signal line, and the transparent conductive layer is arranged above the repairing line.

In yet another aspect of the present invention, the signal line is arranged above the repairing line, and the transparent conductive layer is arranged above the signal line.

The present invention provides an additional transparent conductive layer with a lower melting point on an overlap of a repairing line and a signal line, and uses laser beam to melt the transparent conductive layer to connecting the repairing line and the signal line, thereby increasing a repairing possibility as repairing the signal line.

### BRIEF DESCRIPTION OF THE DRAWINGS

FIG. 1 shows a structure diagram of a display panel according to a preferred embodiment of the present invention.

FIG. 2 shows a structure diagram of the array substrate shown in FIG. 1.

FIG. 3 shows a diagram of an arrangement of the repairing line in the display panel according to a first embodiment of the present invention.

FIG. 4 shows a cross-sectional view of the repairing line along with an AA direction in FIG. 3.

FIG. 5 shows a diagram of an arrangement of the repairing line in the display panel according to a second embodiment of the present invention.

FIG. 6 shows a cross-sectional view of the repairing line along with an AA direction in FIG. 5.

FIG. 7 shows a flow chart of a method of repairing signal lines in a display panel according to a preferred embodiment of the present invention.

FIG. 8 shows a diagram of repairing signal lines in a display panel according to the present invention.

### DETAILED DESCRIPTION OF THE PREFERRED EMBODIMENTS

These and other features, aspects and advantages of the present disclosure will become understood with reference to the following description and accompanying figures.

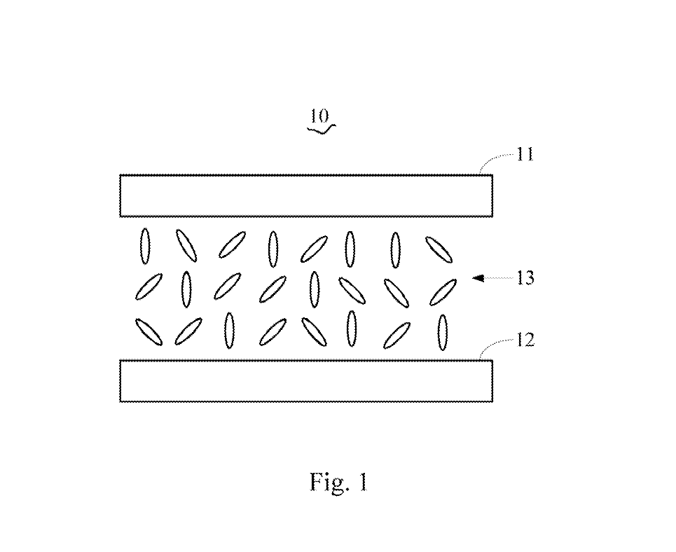

FIG. 1 shows a structure diagram of a display panel according to a preferred embodiment of the present invention. As FIG. 1 shows, a display panel 10 comprises an array substrate 11, a color filter substrate 12 and a liquid crystal layer 13.

The array substrate 11 and the color filter substrate 12 are arranged relatively, and the liquid crystal layer 13 is filled between the array substrate 11 and the color filter substrate 12.

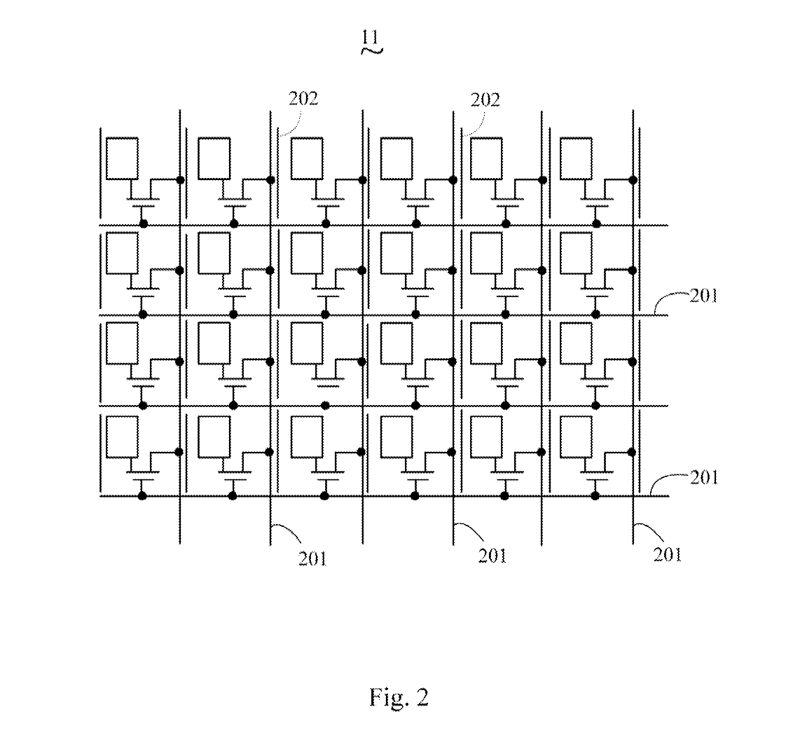

As FIG. 2 shows, the array substrate 11 according to an embodiment of the present invention comprises a plurality of signal lines 201, a plurality of repairing lines 202 and a plurality of transparent conductive layers (not shown).

The signal lines 201 indicates driving lines of the display panel 10. For instance, the signal lines 201 in the array substrate 11 according to the embodiment are scan lines or data lines arranged perpendicularly and intersectionally with each other.

It is ought to be understood that the signal lines 201 in other embodiments of the present invention can be common lines. The common line is a sort of connecting line. An insulating layer is set up between different conductive pattern layers in a liquid crystal display panel for insulating. There is a need for a electrical connection between the different conductive pattern layers, such as an electrical connection between pixel electrodes and drains of thin film transistors being required, however, a perforation (contact hole) is formed in the insulating layer, so that the pixel electrodes in the insulating layer are capable of connecting to the drains of thin film transistors through the perforation. The connecting line between the pixel electrodes and the drains is a sort of common line.

The repairing lines 202 are further arranged in the array substrate 11 in the embodiments of the present invention for repairing the signal lines 201.

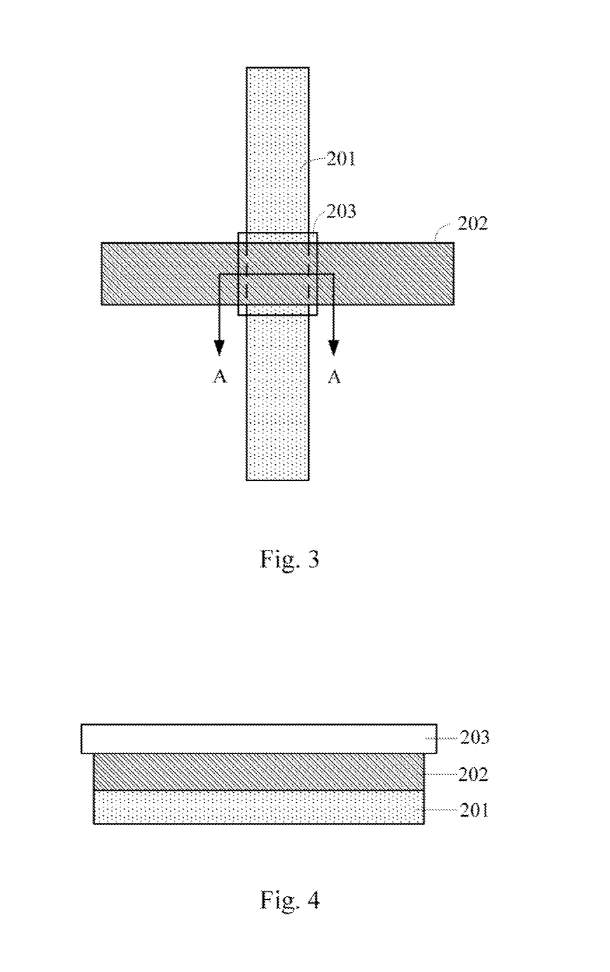

FIG. 3 shows a diagram of an arrangement of the repairing line in the display panel according to a first embodiment of the present invention. FIG. 4 shows a cross-sectional view of the repairing line along with an AA direction in FIG. 3.

Refer to FIG. 3 in conjunction to FIG. 4. The signal line 201 and the repairing line 202 are set up intersectionally and in different layers. In addition, the repairing line 202 is set up above the signal line 201, and the transparent conductive layer 203 is set up above the intersectionally-overlapped area of the signal line 201 and the repairing line 202.

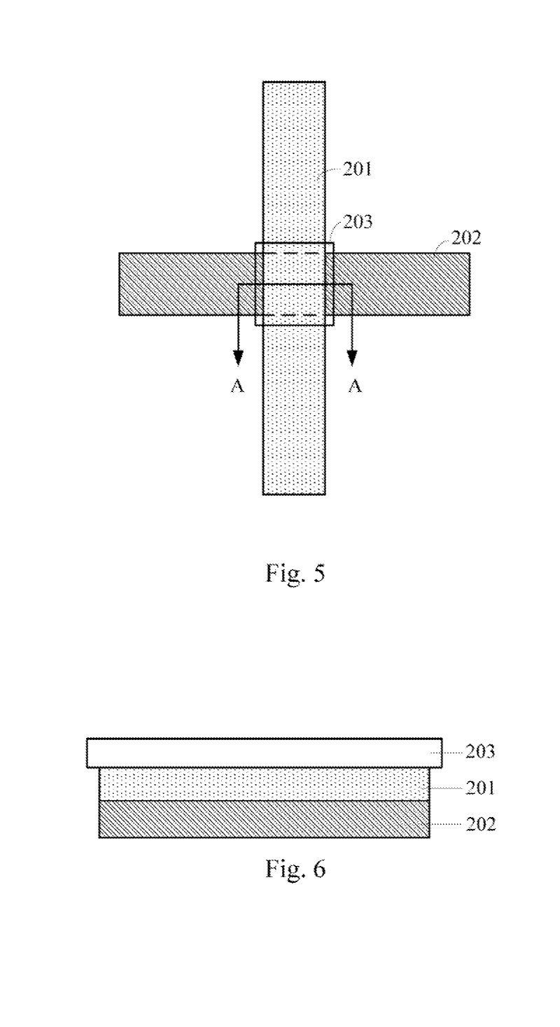

FIG. 5 shows a diagram of an arrangement of the repairing line in the display panel according to a second embodiment of the present invention. FIG. 6 shows a cross-sectional view of the repairing line along with an AA direction in FIG. 5.

Refer to FIG. 5 and FIG. 6. The relative position and the practical method of the signal line 201 and the repairing line 202 in the embodiment are both different to those shown in FIG. 3. The details are:

the signal line 201 is set up above the repairing line 202, and the transparent conductive layer 203 is set up above the signal line 201.

The signal line 201 and the repairing line 202 are made of Aluminum or Copper. The transparent conductive layer 203 is made of Indium Tin Oxides (ITO) or Indium Zinc Oxides IZO).

Furthermore, the working principle of repairing the signal lines in the display panel of the present invention is: it uses laser beams to concentrate on the transparent conductive layer 203 to lead the transparent conductive layer 203 into melting state when there is a necessity of repairing a broken signal line 201. The transparent conductive layer 203 in the melting state is capable of preheating the signal line 201 and the repairing line 202 because the melting point of the transparent conductive layer 203 is lower than that of the signal line 201 and the repairing line 202. There is going to be an effective conduction between the signal line 201 and the repairing line 202 even though the energy of laser beams decreases as time lapses.

Based on the above-mentioned method of repairing a signal line, it just needs to arrange the transparent conductive layer 203 above the intersectionally-overlapped area of the signal line 201 and the repairing line 202 without restricted limitation of position relations between the signal line 201 and the repairing line 202.

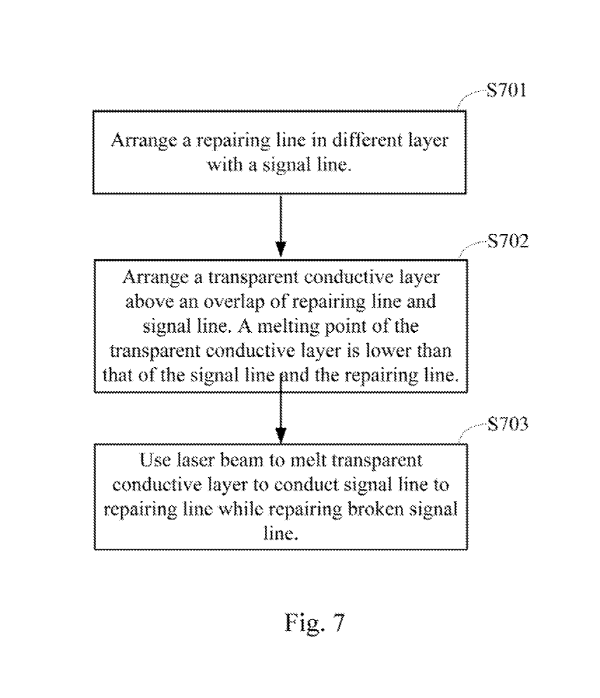

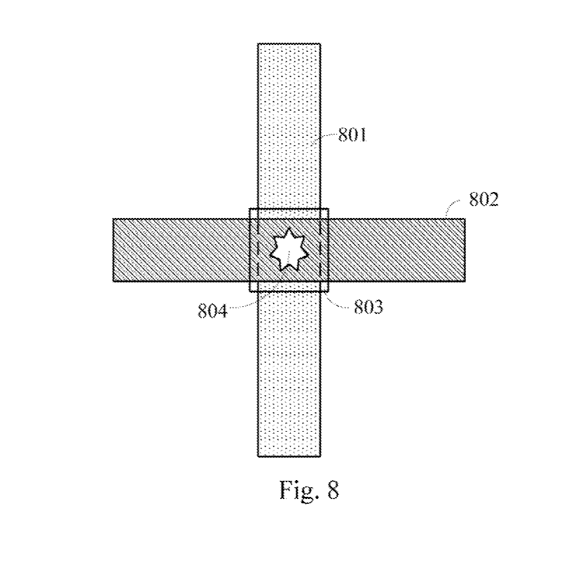

FIG. 7 shows a flow chart of a method of repairing signal lines in a display panel according to a preferred embodiment of the present invention. FIG. 8 shows a diagram of repairing signal lines in a display panel in the present invention. Combining FIG. 7 with FIG. 8, the method of repairing signal lines in a display panel according to the present invention comprises following steps:

Step S701: arranging a repairing line 802 in different layer with a signal line 801;

the signal line 801 whose material is Aluminum or Copper can he a scan line, a data line perpendicularly and intersectionally or a common line on an array substrate of the display panel.

The repairing line 802 in the embodiment is arranged above the signal line 801. The signal line 801 in other embodiments, however, is capable of being arranged above the repairing line 802.

Step S702: arranging a transparent conductive layer 803 above the intersectionally-overlapped area of the repairing line 802 and the signal line 801, and the melting point of the transparent conductive layer 803 is lower than that of the signal line 801 and the repairing line 802;

a material of the transparent conductive layer 803 is ITO or IZO.

The transparent conductive layer 803 in the embodiment is arranged above the repairing line 802. The transparent conductive layer 803 in other embodiments, however, is capable of being arranged above the signal line 801.

Step S703: using the laser beams focusing on the transparent conductive layer 803 for melting the transparent conductive layer 803 to connect the signal line 801 and the repairing line 802 while repairing the broken signal line 801.

In Step S703, the point which the laser beams concentrating to is a laser repairing point 804 when the broken signal line 801 needs to be repaired. And the laser beams melt the laser repairing point 804 in the transparent conductive layer 803. The melted transparent conductive layer 803 is capable of preheating the signal line 801 and the repairing line 802 because of the melting point of the transparent conductive layer 803 is lower than that of the signal line 801 and the repairing line 802. Even if the energy of laser beams lessens as time lapses, the signal line 801 and the repairing line 802 are capable of being conducted.

In sum, the present invention provides an additional transparent conductive layer with a lower melting point to he disposed on an overlap of a repairing line and a signal line, and uses laser beam focusing on the transparent conductive layer for being melted to connecting the repairing line and the signal line to increase repairing possibility as repairing the signal line.

While the present invention has been described in connection with what is considered the most practical and preferred embodiments, it is understood that this invention is not limited to the disclosed embodiments but is intended to cover various arrangements made without departing from the scope of the broadest interpretation of the appended claims.

What is claimed is:

1. A method of repairing a signal line in a display panel, comprising:
arranging a repairing line in a different layer with the signal line, the repairing line being set up above the signal line, the signal line being data line, scan line or common line;
arranging a transparent conductive layer above an intersectionally-overlapped area of the repairing line and the signal line, a melting point of the transparent conductive layer is lower than that of the signal line and the repairing line;
using laser beam to melt the transparent conductive layer to connect the signal line and the repairing line when repairing the broken signal line.

2. The repairing method of claim 1, wherein the signal line is made of Aluminum or Copper. and the transparent conductive layer is made of Indium Tin Oxides (ITO) layer or Indium Zinc Oxides (IZO) layer.

3. A method of repairing a signal line in a display panel, comprising:
arranging a repairing line in a different layer with the signal line,
arranging a transparent conductive layer above an intersectionally-overlapped area of the repairing line and the signal line, a melting point of the transparent conductive layer is lower than that of the signal line and the repairing line;
using laser beam to melt the transparent conductive layer to connect the signal line and the repairing line when repairing the broken signal line.

4. The repairing method of claim 3, wherein the repairing line is a data line, a scan line or a common line.

5. The repairing method of claim 3, wherein the signal line is made of Aluminum or Copper, and the transparent conductive layer is made of Indium Tin Oxides (ITO) layer or Indium Zinc Oxides (IZO) layer.

6. The repairing method of claim 3, wherein the repairing line is set up above the signal line, the transparent layer is set up above the repairing line.

7. The repairing method of claim 3, wherein the signal line is set up above the repairing line, the transparent layer is set up above the repairing line.

8. A display panel comprising: a relatively-arranged array substrate, a color filter substrate and a liquid crystal layer clamped between the array substrate and the color filter substrate, a plurality of signal lines and repairing lines being set up in the array substrate, and the repairing lines and the signal lines being set up intersectionally and respectively in different layers, wherein a transparent conductive layer is arranged above an intersectionally-overlapped area of repairing lines and the signal lines, and a melting point of the transparent conductive layer is lower than that of the signal line and the repairing line.

9. The display panel of claim 8, wherein the signal line is data line, scan line or common line.

10. The display panel of claim 8, wherein the signal line is made of Aluminum or Copper, and the transparent conductive layer is made of ITO layer or IZO layer.

11. The display panel of claim 8, wherein the repairing line is arranged above the signal line. and the transparent conductive layer is arranged above the repairing line.

12. The display panel of claim 8, wherein the signal line is arranged above the repairing line. and the transparent conductive layer is arranged above the signal line.
